(19) United States
(12) Patent Application Publication
(10) Pub. No.: US 2024/0378945 A1
(43) Pub. Date: Nov. 14, 2024

(54) GAMING MACHINE WITH POSITIONALLY CORRELATED SECONDARY EVENT FEATURE

(71) Applicant: LNW Gaming, Inc., Las Vegas, NV (US)

(72) Inventor: George BOUVIER, Henderson, NV (US)

(21) Appl. No.: 18/658,622

(22) Filed: May 8, 2024

Related U.S. Application Data
(60) Provisional application No. 63/501,275, filed on May 10, 2023.

(51) Int. Cl. G07F 17/32; G07F 17/34

(52) U.S. Cl. CPC G07F 17/3213; G07F 17/3267; G07F 17/34

(57) ABSTRACT

There is provided an example gaming system (and method) to perform operations that present a primary game that lands, on primary-game reels or a primary-game array, a plurality of primary-game symbols and also lands at least one special symbol on at least one of the primary-game reels. The operations further trigger a secondary game wherein, for each spin of the secondary game, the operations animate, based on a random number generator, occurrence of a secondary determination event in at least one of a plurality of portions of a secondary-game array. In response to animation of the occurrence of the secondary determination event, the operations enhance the at least one special symbol based on a positional correlation between a position of the at least one of a plurality of portions within the secondary-game array and a position of the at least one of the primary-game reels within the primary-game array.

### CROSS-REFERENCE TO RELATED APPLICATION(S)

This patent application claims priority benefit of U.S. Provisional Patent Application No. 63/501,275 filed May 10, 2023. The disclosure of the 63/501,275 application is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023, LNW Gaming, Inc.

### FIELD OF THE INVENTION

The present invention relates to a technological improvement to gaming systems, gaming machines, and methods thereon and, more particularly, to new and improved animations in connection with a bonus feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

According to an embodiment of the present disclosure, there is provided a gaming system, gaming machine, method, etc. to perform operations to accept, via a value input device, a physical item associated with a monetary value to establish a monetary balance. The operations further present, via a presentation assembly, primary-game reels that form a primary-game array for a primary game, the primary-game reels bearing a plurality of primary-game symbols and a plurality of special symbols. The operations further land, on the primary-game reels, at least some of the plurality of primary-game symbols and a special symbol from the plurality of special symbols. The special symbol lands on at least one of the primary-game reels. The operations further determine a random trigger to present play of a secondary game using a secondary-game array. The secondary-game array comprises a plurality of portions. The operations further animate, in response to determination of the random trigger, a random occurrence of a secondary determination event in one of the plurality of portions of the secondary-game array. The operations further determine, in response to animation of the occurrence of the secondary determination event, a positional correlation between a first position of the one of the plurality of portions within the secondary-game array and a second position of the one of the primary-game reels within the primary-game array. The operations further enhance, in response to determination of the positional correlation, the special symbol.

According to an additional embodiment of the present disclosure, there is provided a gaming system, gaming machine, and method that performs, by game-logic circuitry, operations to accept, via a value input device, a physical item associated with a monetary value to establish a monetary balance and to present, by a presentation assembly, primary-game reels that form a primary-game array for a primary game, the primary-game reels bearing a plurality of primary-game symbols and a plurality of special symbols. The operations, by the game-logic circuitry, further conduct, via a random number generator, one or more primary-game spins of the primary-game reels for the primary game, each primary-game spin including spinning and stopping the primary-game reels to land, in the primary-game array, a first set of symbols from the plurality of primary-game symbols and a second set of symbols from a plurality of special symbols. The operations further determine, during the one or more primary-game spins, a random trigger to present play of a secondary game using a secondary-game array. The secondary-game array comprises a plurality of portions within which a secondary determination event can occur during the secondary game. Each one of the plurality of portions corresponds to at least a respective one of the primary-game reels according to a positional correlation. The operations further conduct, by the game-logic circuitry in response to determination of the random trigger, one or more secondary-game spins for the secondary game. For each secondary-game spin, the operations further: animate, based on the random number generator, occurrence of the secondary determination event in at least one of the plurality of portions of the secondary-game array; and in response to animation of the occurrence of the secondary determination event, enhance at least one of the second set of symbols on the at least a respective one of the primary-game reels based on the positional correlation.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a block diagram of a gaming system according to an embodiment of the present invention.

FIG. 3 is a flow diagram for a data processing method that corresponds to instructions executed by game-logic circuitry, according to an embodiment of the present invention.

FIGS. 4-14 are an exemplary representation of a series of game cycle events and/or outcomes (i.e., spin outcomes) for a secondary feature according to an embodiment of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

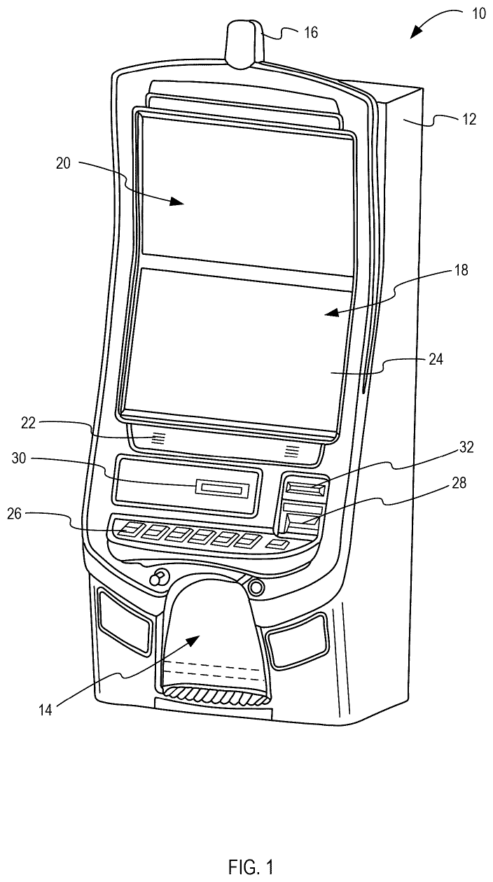

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

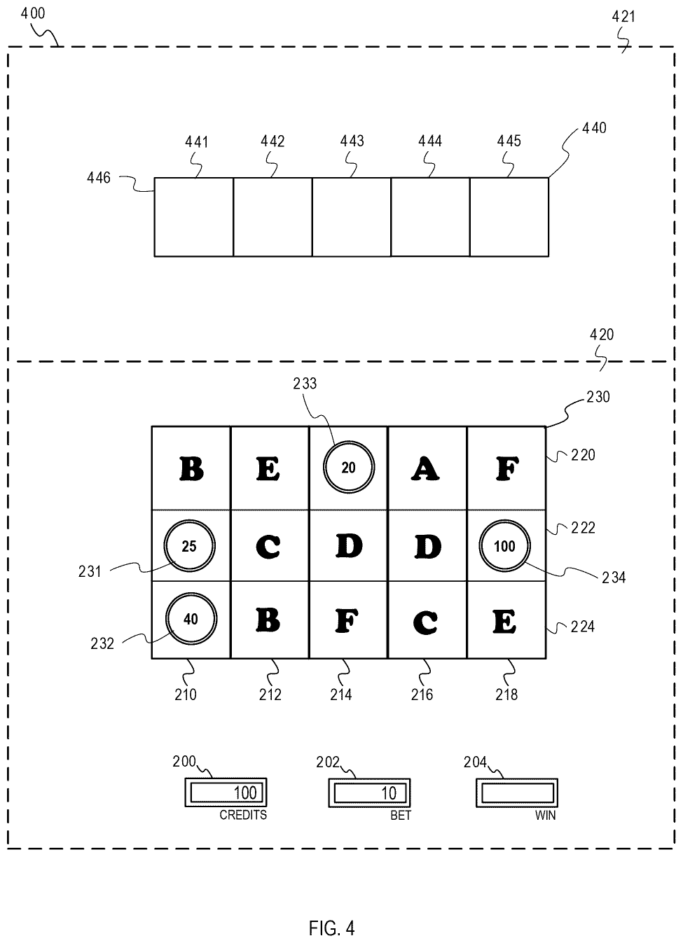

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIGS. 4-14). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the credits meter (e.g., credit meter 200, see FIGS. 4-14), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

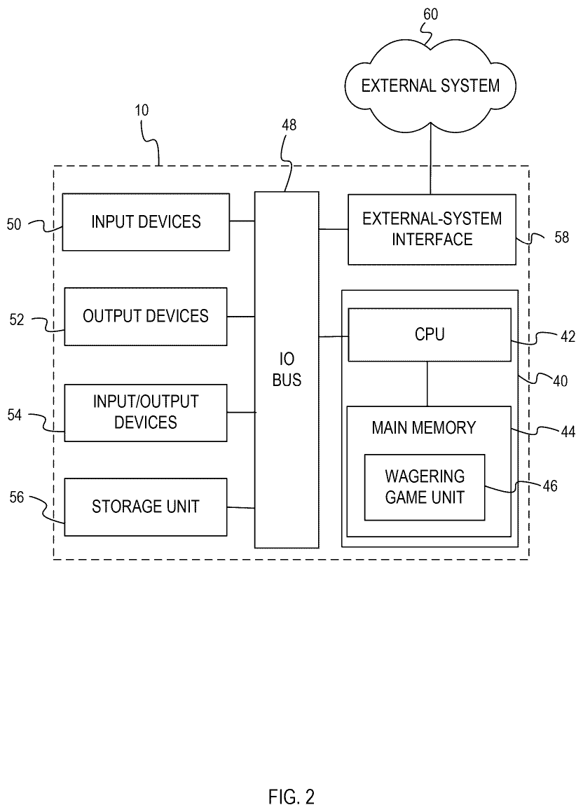

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video black jack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compares it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry 40 facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be implemented with hardware and software architectures, circuitry, and other special features that differentiate it from general-purpose computers (e.g., desktop PCs, laptops, and tablets).

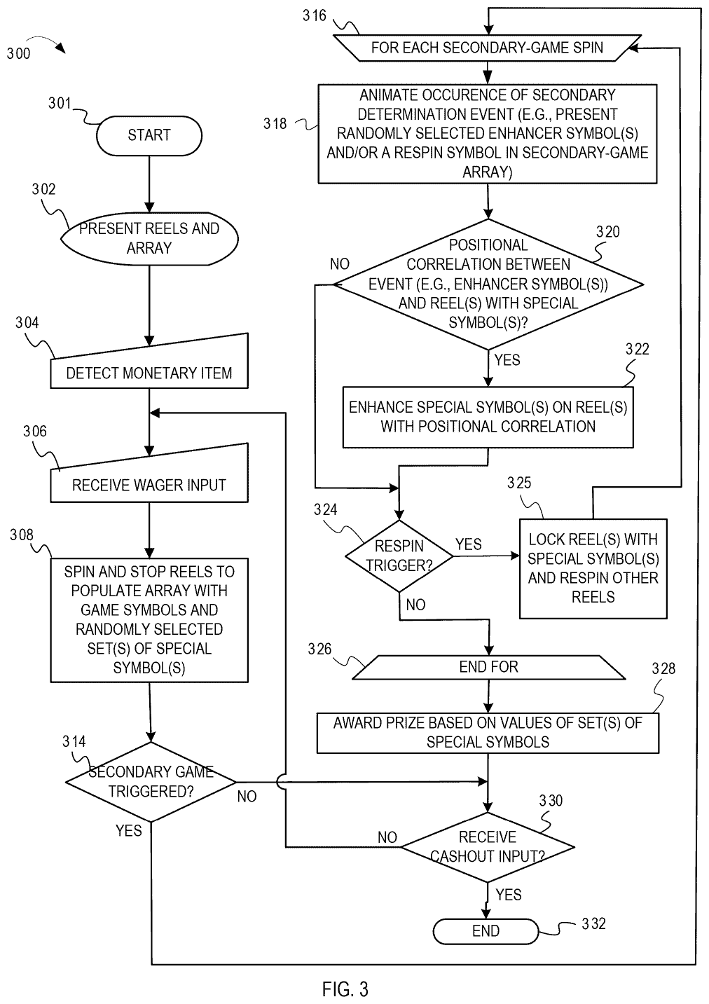

Referring now to FIG. 3, there is shown a flowchart representing one data processing method corresponding to at least some instructions stored and executed by the game-logic circuitry 40 in FIG. 2 to perform operations according to an embodiment of the present invention. The data processing method is described below in connection with an exemplary representation of a series of feature game cycles (including presentation of the game cycle/spin outcomes) in FIGS. 4-14.

The data processing method follows a flow 300, which commences at processing block 301. The flow 300 continues at processing block 302, where game-logic circuitry controls one or more presentation devices (e.g., mechanical-reel display device, video display device, or a combination thereof) that presents a plurality of symbol-bearing reels and an array of symbol positions. Although the method is described with respect to one presentation device, it is to be understood that the presentation described herein may be performed by a presentation assembly including more than one presentation device. The symbol positions of the array may be arranged in a variety of configurations, formats, or structures and may comprise a plurality of rows and columns. The rows of the array are oriented in a generally horizontal direction, and the columns of the array are oriented in a generally vertical direction. The symbol positions in each row of the array are horizontally aligned with each other, and the symbol positions in each column of the array are vertically aligned with each other. The number of symbol positions in different rows and/or different columns may vary from each other. The reels may be associated with the respective columns of the array such that the reels spin vertically and each reel populates a respective column. In another embodiment, the reels may be associated with the respective rows of the array such that the reels spin horizontally and each reel populates a respective row. In yet another embodiment, the reels may be associated with respective individual symbol positions of the array such that each reel populates only its respective symbol position.

In the example shown in FIG. 4, the presentation device (e.g., presentation device(s) 400) presents (on a primary presentation device 420) a primary-game array 230, such as a three-by-five array comprising three rows 220, 222, 224 and five columns 210, 212, 214, 216, 218). Each column is associated with a respective reel such that the reel populates the three symbol positions in the associated column. The reels bear a plurality of symbols. In one embodiment, the plurality of symbols include standard symbols (e.g., A, B, C, D, E, and F) and special symbols, such as value-bearing symbols (e.g., value-bearing symbols 231, 232, 233, and 234). The standard symbols are used during base-game spins to determine outcomes of the base game. Each special symbol is associated with a secondary game. Further, each special symbol has a value associated with it that can be enhanced by one or more secondary determination events that occur from the secondary game. As mentioned, one type of special symbol is a value-bearing symbol. In one example, the value-bearing symbol is associated with a credit or currency value indicated on the symbol itself. The value on a particular one of the value-bearing symbols may be fixed or variable (e.g., random) from one game cycle to the next. Different value-bearing symbols on the reels may have different values. Each reel may contain one or more stacks (i.e., clumps) of value-bearing symbols that appear adjacent to each other along the reel. The values of the value-bearing symbols in any given stack may be the same or different. A stack of value-bearing symbols may consist of two, three, four, or more adjacent symbols. In some embodiments, the value-bearing symbols may appear only on specific portions of the array 230. Furthermore, in one embodiment, each of the value-bearing symbols may be associated with one of a plurality of different types having different characteristics (e.g., colors, styles, sizes, text descriptions, special effects, ranges of value, etc.).

Also shown in FIG. 4, the presentation device(s) 400 presents (either via the primary presentation device 420 or via a secondary presentation device 421) a secondary-game array 440. Game-logic circuitry (e.g., game-logic circuitry 40) randomly presents, via the secondary-game array 440, secondary-game symbols, such as enhancer symbols (see processing block 318) which are used to enhance any special symbol(s) in the primary-game array 230 that have positional correlation with physical locations of enhancer symbols presented in portions (e.g., columns) of the secondary-game array 440 (see processing block 322 for more details). For instance, in some embodiments, the game-logic circuitry can apply enhancer symbols to special symbols such as cash-value or value-bearing symbols to increase (e.g., multiply) or otherwise augment a value associated with the value-bearing symbol or a value associated with some other primary-game element. In some embodiments, the game-logic circuitry can enhance (e.g., apply enhancer symbols to) specific standard symbols. Further, in some embodiments, the game-logic circuitry can enhance other elements of the primary game, such as by enhancing wild symbols, specific lines, etc. For example, enhancer symbols can multiply line wins from the primary game or can add wilds to the primary array (to potentially complete lines from the primary game).

Returning to FIG. 3, after processing block 302, the flow 300 continues at processing block 304, where the game-logic circuitry detects, via a value input device, a physical item associated with a monetary value that establishes a credit balance. As shown in FIGS. 4-14, the credit balance may be shown on the credit meter 200 of the gaming machine. Furthermore, win amounts for a game event (e.g., a primary-game event, a secondary-game event, etc.), can be presented in a win meter 204.

The flow 300 continues at processing block 306, where the game-logic circuitry initiates a wagering game cycle in response to an input indicative of a wager covered by the credit balance. To initiate a spin of the reels, the player may press a “Spin” or “Max Bet” key on a button panel or touch screen. As shown in FIGS. 4-14, the wager may be shown on a bet meter 202.

The flow 300 continues, at processing block 308, where, using an RNG, the game-logic circuitry spins and stops the reels to randomly land standard and/or special symbols (e.g., value-bearing symbols) from the reels in the array 230 in visual association with one or more paylines (also known as lines, ways, patterns, or arrangements). The reel spin may be animated on a video display by depicting symbol-bearing strips moving vertically across the display and synchronously updating the symbols visible on each strip as the strip moves across the display. The reel spin may land the standard symbols and/or the one or more sets of special symbols (e.g., as presented in the array 230 shown in FIG. 4). Each of the one or more sets of special symbols may include one or more value-bearing symbols. As shown in FIG. 4-14, the sets of special symbols are depicted as having only one member per set (e.g., a set of one value-bearing symbol), however it is possible that more than one value-bearing symbol may be included in a set (e.g., a stack of value-bearing symbols).

Referring again to FIG. 3, at processing block 314, the game-logic circuitry determines whether a secondary-game trigger occurs to begin the secondary game (also referred to herein as a “feature” game). For example, the secondary-game trigger can be a random mystery trigger (e.g., via the RNG). In another example, the secondary-game trigger is occurrence of a catalyst in the primary game, such as whether a threshold number of (e.g., at least one of) the special symbols (e.g., value-bearing symbols) appears on the primary-game reels. For instance, the secondary-game trigger may occur when three or more special symbols appear. In another example, the secondary-game trigger is an appearance of the special symbols on a threshold number of the primary-game reels (e.g., trigger occurs when special symbols appear on two or more reels). In another example, the secondary-game trigger can occur based on the special symbols being oriented in a specific manner (e.g., in a specific direction or location, on three adjacent reels or along a specific pay line, etc.). In another example, the secondary-game trigger occurs in some other way (e.g., a specific secondary-game trigger symbol appears, a specific base game symbol appears (e.g., a wild symbol), etc.).

If, at processing block 314, the secondary game is not triggered, the game-logic circuitry immediately proceeds to processing block 330. If, however, the secondary game is triggered, the game-logic circuitry proceeds to processing block 316 where the game-logic circuitry begins a loop. Each instance of the loop occurs for each spin of the secondary game. The loop includes the processing blocks 316 through 326 and either repeats (at processing block 316) or ends (at processing block 326) based on whether termination criteria for the loop has been met or not (e.g., termination criteria can include failure of a re-spin trigger fails to appear in the secondary-game array 440 (e.g., processing block 324)). The loop begins with a first of the bonus spins. The loop ends after a last bonus spin completes, for example when termination criteria is met.

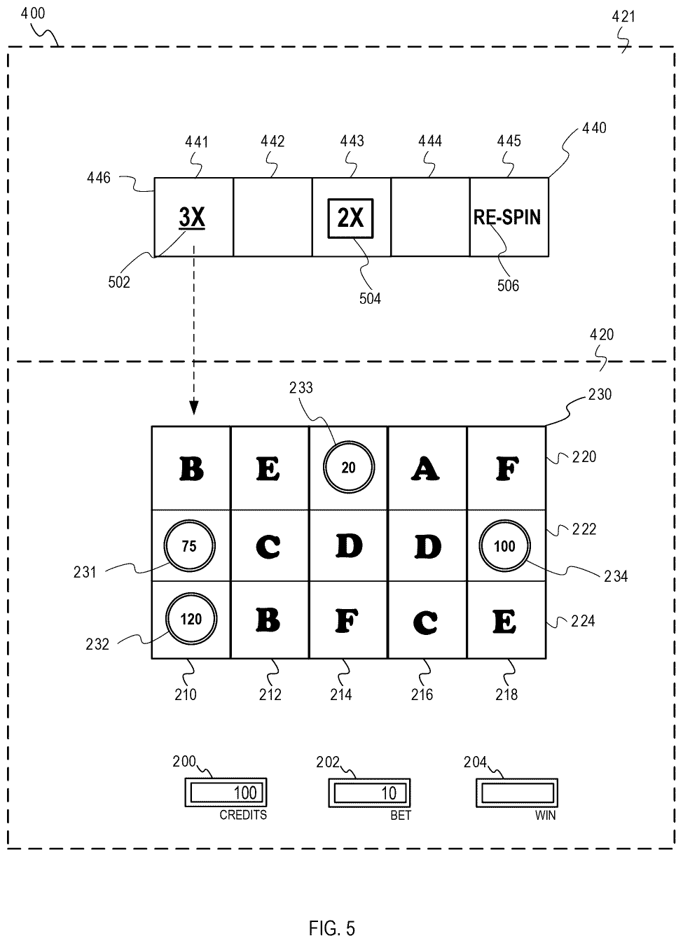

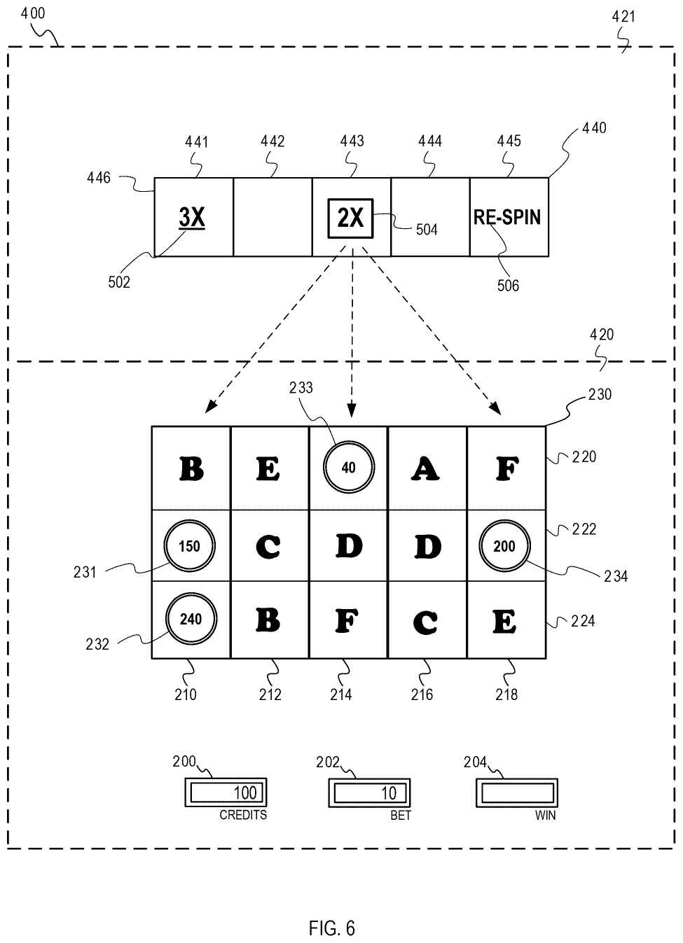

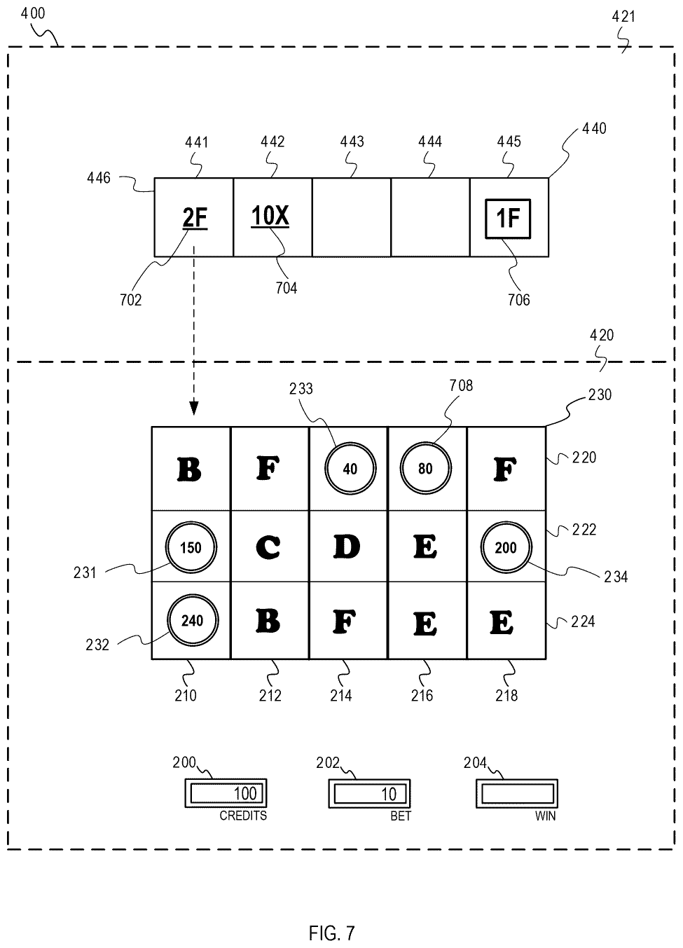

The flow 300 continues, at processing block 318, where the game-logic circuitry animates occurrence of a secondary determination event in at least one of the portions of the secondary-game array. In one example, animating the occurrence of the secondary determination event includes animating presentation of one or more secondary-game symbols (e.g., randomly selected enhancer symbol(s)) and/or a trigger symbol (e.g., a re-spin symbol which indicates one or more additional free spins for the secondary game). For example, FIG. 5 illustrates a state of the secondary-game array 440 in response to a first secondary-game spin. The secondary-game array 440 includes a single row 446 and five columns 441, 442, 443, 444, and 445. In one example, the row 446 is a secondary game reel that spins horizontally. The row 446 may thus also be referred to as reel 446, or more specifically as a secondary-game reel or a horizontal reel. Enhancer symbols are symbols that describe or refer to a game element that can modify (e.g., increase or augment) a value of a special symbol or other element of value presented within or via the primary-game array 230. In one example, the enhancer symbol is a multiplication type enhancer symbol (e.g., a multiplier symbol). In another example, the enhancer symbol is a dynamic type enhancer symbol (e.g., a flip symbol). Examples of applying multiplier symbols are shown in FIG. 5-6. Examples of applying flip symbols are shown in FIG. 7-14.

Referring back to FIG. 3, the flow 300 continues at processing block 320 where the game-logic circuitry determines whether a positional correlation exists between a given position of the secondary determination event (e.g., based on a position of an enhancer symbol within an identifiable portion (e.g., a column of) the secondary-game array 440) and a given position of a special symbol in the primary-game array (e.g., a position of a value-bearing symbols within a correlated vertical reel of) the primary-game array 230). If a positional correlation exists, then at processing block 322, the game-logic circuitry enhances the special symbol(s) on primary-game reels that correspond to the positional correlation. In one example, each portion (e.g., each of the columns 441, 442, 443, 444, and 445) corresponds to a respective one of the primary-game reels according to physical locality or positionally equivalent locations within the given game array. For example, the primary-game array includes five horizontal reels (i.e., reels 210, 212, 214, 216, and 215), which are positioned directly beneath, and align vertically with, the columns 441, 442, 443, 444, and 445 of the horizontal reel 446. Thus, the first column 441 corresponds, in position within the secondary-game array 440, to an equivalent position of the first reel 210 in the primary-game array 230. In other words, column 441 maps to at least reel 210. Likewise, the second column 442 maps to at least the second reel 212 (i.e., the second column 442 corresponds, in position within the secondary-game array 440, to an equivalent position of the second reel 212 in the primary-game array 230). In like manner, the third column 443 maps to at least the third reel 214 in the primary-game array 230 and the fourth column 444 maps to at least the fourth reel 216 in the primary-game array 230. Furthermore, the fifth column 445 maps to at least the fifth reel 218 in the primary-game array 230.

One type of enhancer symbol (a single-correlation enhancer symbol) has a one-to-one positional correlation that relates a single one of the columns 441, 442, 443, 444, or 445 to a single one of the reels 210, 212, 214, 216, or 218 for purposes of enhancement. For instance, a single-correlation multiplier symbol (multiplier symbol 502) appears in column 441, which column 441 corresponds in position to that of reel 210 (e.g., is directly above the reel 210). Because the multiplier symbol 502 is a single-correlation type multiplier symbol, then it enhances only the special symbols (e.g., value-bearing symbols 231 and 232) that are in the one, positionally correlated primary-game reel 210 that is directly below the corresponding column 441 of the secondary-game array 440. For example, the multiplier symbol 502 multiplies (by three) each of the values on the value-bearing symbols 231 and 232 on reel 210. However, because of the single-correlation type of multiplier symbol 502, the multiplier symbol 502 does not have provide positional correlation with other primary-game reels, thus it does not enhance the value-bearing symbol 233 nor the value-bearing symbol 234. On the other hand, multiplier symbol 504 is an example of a multi-correlation type of multiplier symbol. In other words, the multiplier symbol 504 has a one-to-many relationship of positional correlation (e.g., the multiplier symbol 504 is a type of enhancer symbol that provides a positionally correlated relationship to many of the primary-game reels of the primary-game array 230. For example, in response to the appearance of the multiplier symbol 504, the game-logic circuitry applies enhancement to more than one reel on the primary-game array 230, such as to a primary-game reel 214 that is directly below the column 443 in which the multiplier symbol 504 appeared, as well as to one or more primary-game reels (e.g., to any primary-game reels that are adjacent to the column 443, to any primary-game reels that are in a certain direction related to the column 443, to all primary-game reels in the array 230, etc.). In the example of FIG. 5 and FIG. 6, the multiplier symbol 504 a type of multi-correlation enhancer symbol that applies to all of the primary-game reels of the primary game array 230, such as is shown in FIG. 6 (i.e., the multiplier symbol 504 multiplies (by two) the value of the value-bearing symbol 233, as well as values of the value-bearing symbols 231, 232, and 234). In some embodiments, the multiplier symbol 504 may be referred to as a “super” multiplier in that it applies to all of the primary-game reels in which a special symbol appears. In another embodiment, the multiplier symbol may be referred to as an “expander” type of enhancer symbol which can apply to the column directly below and to any adjacent columns.

In some embodiments, an expander type of enhancer symbol can have various additional types. For example, one type of expander symbol may be referred to herein as a directional expander symbol, which has positional correlation in a certain direction (e.g., to the right, left, etc.) relative to the position of the enhancer symbol within the secondary-game array. For example, if an enhancer symbol is a “right” directional expander symbol, the enhancer symbol would apply enhancement to special symbol(s) on a primary-game reel that is directly below the right directional expander symbol as well apply enhancement to special symbol(s) on primary-game reels that are the right of the right directional expander symbol. On the other hand, if an enhancer symbol is a “left” directional expander symbol, the left directional expander symbol would apply enhancement to special symbol(s) on a primary-game reel that is directly below the left directional expander symbol as well apply enhancement to special symbol(s) on primary-game reels that are the left of the left directional expander symbol. For example, an enhancer symbol (e.g., a multiplier or flip symbol) may include an arrow that points either to the left or right, and thus any primary-game reels that are either directly below or in the specific direction of the pointing arrow are enhanced (e.g., in FIG. 6, if the multiplier symbol 504 had an arrow that pointed to the left, the game-logic circuitry would have enhanced value-bearing symbols on the reel 214 (which is directly below the multiplier symbol 504) as well as value-bearing symbols on both reels 210 and 212 (which are to the left of the super multiplier 504), but would not enhance the value-bearing symbols on reels 216 and 217 (which are to the right of the multiplier symbol 504)). On the other hand, if the multiplier symbol 504 had been a right directional expander symbol (e.g., had an arrow that pointed to the right), then the game-logic circuitry would have applied enhancement to the value-bearing symbols on reel 214 (which is directly below the multiplier symbol 504) as well as to value-bearing symbols on reels 216 and 218 (e.g., applies enhancement to the value-bearing symbol 234 on reel 218 (which is to the right of the multiplier symbol 504)). However, the game-logic circuitry would not have applied enhancement to value-bearing symbols 231 or 232 because they are on primary-game reels that are to the left of the multiplier symbol 504. If a special symbol had been on reel 216, then the multiplier symbol 504 would have also applied enhancement to any special symbol on reel 216.

In some embodiments, the game-logic circuitry can also modify primary-game reels based on the appearance of enhancer symbols. In one example, a modified reel can increase the number of cells within a column/reel of the primary-game array to allow for more possible random appearances of value-bearing symbols within the primary-game array. The modified reel can accommodate the additional cells by either expanding the reel to make it look physically longer on the display (i.e., an “expander” reel) or by compressing the existing space on a reel to accommodate for more cells within the same physical area of the primary-game reel.

Referring back to FIG. 3, at processing block 324, where the game-logic circuitry determines whether a re-spin condition is met, such as whether a re-spin symbol randomly appeared in the secondary-game array 440. If a re-spin trigger occurs, then the flow 300 continues at processing block 325, where the game-logic circuitry locks any portions of the primary-game reels that have special symbols and re-spins other portions of the primary-game reels to cause additional sets of special symbols to potentially appear randomly in the primary-game array. The loop then repeats (at processing block 316) for an additional secondary-game spin. If, however, no re-spin trigger occurs, then the loop ends (at processing block 326) and the flow 300 continues at processing block 328, where the game-logic circuitry awards a prize based on the values of the special symbols in the primary-game array 230 (including the enhanced values of special symbols that occurred via the secondary game).

For example, referring to FIG. 6, after the game-logic circuitry enhances any of the special symbols in the primary-game array 230 based on the respective positional correlation(s) of the enhancer symbol(s), the game-logic circuitry detects that a re-spin trigger occurs (e.g., a “RE-SPIN” symbol appeared, such as symbol 506). Based on the re-spin trigger occurring, the game-logic circuitry locks at least the portions of the the primary-game reels that have special symbols. In one embodiment, the game-logic circuitry locks an entire reel. For example, in FIG. 6, the game-logic circuitry locks reels 210, 214, and 218 (which already include value-bearing symbols). In other embodiments, however, the game-logic circuitry may instead only lock the entries or cells of the primary-game array 230 that contain the value-bearing symbols 231, 231, 233, and 234, and then re-spins all cells of the primary-game array that do not include value-bearing symbols. FIG. 7 illustrates an example of the primary-game array 230 after unlocked reels 212 and 216 are re-spun. As shown, an additional special symbol (e.g., value-bearing symbol 708) has randomly appeared (e.g., via RNG) in reel 216. In some embodiments, if a win event were to occur in the primary-game based on the re-spin of the primary-game reels, then an award can be provided based on the win event. In other embodiments, however, the re-spin of unlocked primary-game reels may not provide any additional wins for the primary game while the secondary game is in progress.

FIG. 7 also illustrates the state of the secondary-game reel (reel 446) after a second spin of the secondary game. The second spin of the reel 446 causes an additional multiplier symbol 704 to randomly appear, as well as two types of dynamic enhancer symbols (e.g., “flip” symbols), including flip symbol 702 and flip symbol 706. Flip symbol 702 is a single-correlation type of enhancer symbol that applies the dynamic enhancement to special symbols on only one of the primary-game reels (e.g., to the primary-game reel that is directly below the enhancer symbol). The flip symbol 706, however, is a multi-correlation type enhancer symbol that applies the dynamic enhancement to special symbols on more than one of the primary-game reels. For instance, the flip symbol 706 applies enhancement to all value-bearing symbols on all of the primary-game reels (thus may be referred to herein as a “super” flip). In some embodiments, for the additional spin, the game-logic circuitry may re-spin the horizontal reel 446 to replace the enhancer symbols (e.g., as illustrated in FIG. 7). In other embodiments, however, the game-logic circuitry may keep the enhancer symbols within the reel 446, and may instead add to the secondary-game array 440 an additional horizontal reel above the existing reel 446. The additional horizontal reel may randomly land additional enhancer symbols, which the game-logic circuitry can apply (e.g., based on positional correlation) to any corresponding enhancer symbols in the reel 446. For example, if the enhancer symbol in a cell in the additional horizontal reel is a single-correlation type of enhancer symbol, then the enhancer symbol would be applied to only the column directly below it in the secondary game array 440 (e.g., if a “2×” single-correlation multiplier had appeared in column 442 of the additional horizontal reel, then the “2×” multiplier would cause the “10×” multiplier symbol 704 below it to be multiplied by two, thus effectively becoming a “20×” multiplier (i.e., 10×2=20), but it would not affect the enhancer symbols in columns 441, 443, 444 or 445). In one embodiment, after the re-spin, the game-logic circuitry first applies the enhancer symbols from the additional horizontal reel (based on their positional correlations) to the value-bearing symbols in corresponding reels of the primary array 230 below, then the game-logic circuitry reapplies the enhancer symbols that remained within the first horizontal (i.e., reel 446) to the value-bearing symbols in the corresponding reels of the primary array 230. In yet another embodiment, prior to the additional spin of the secondary game, the game-logic circuitry can lock any portions of (e.g., cells within) the secondary-game array 440 that include enhancer symbols, and then re-spin only the portions of the secondary-game array 440 that do not contain enhancer symbols.

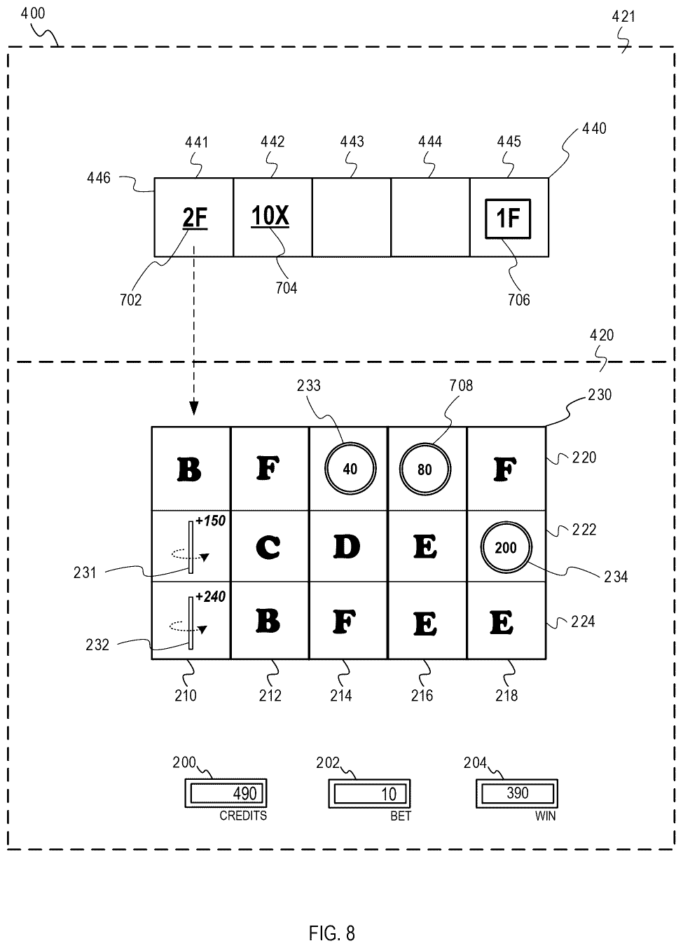

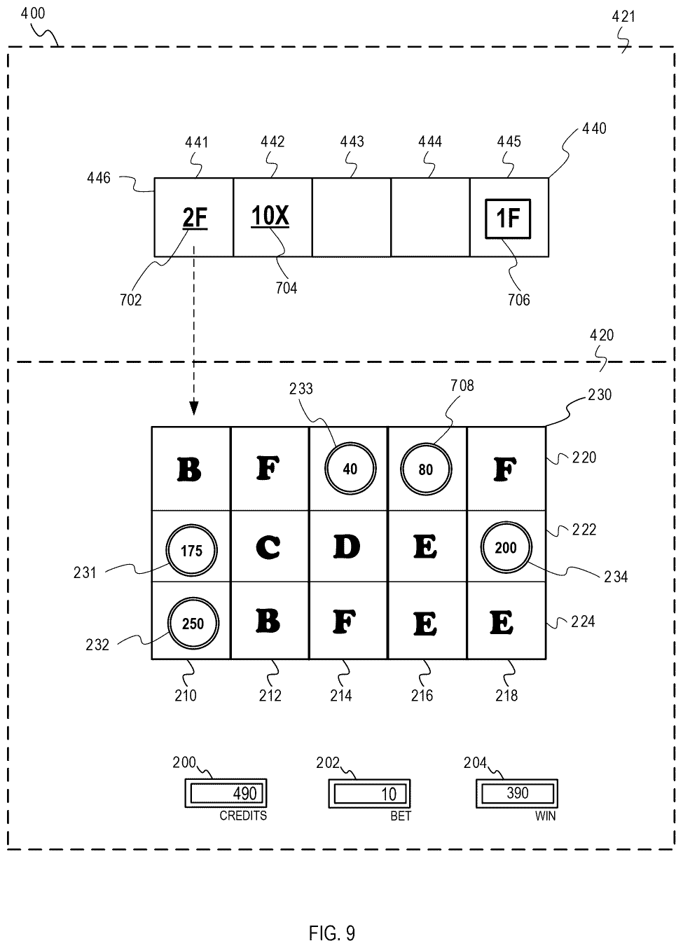

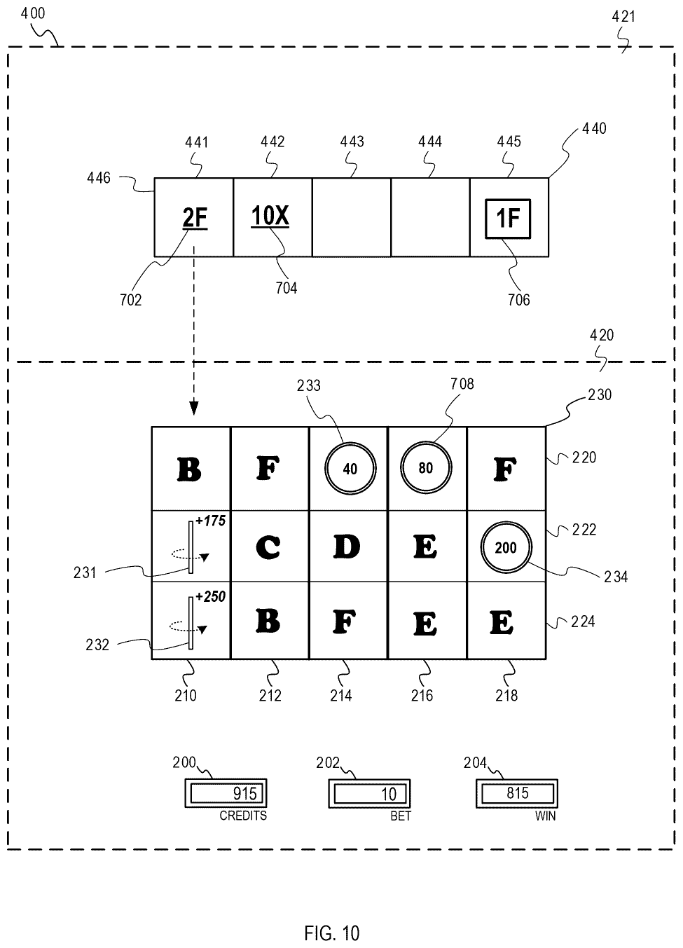

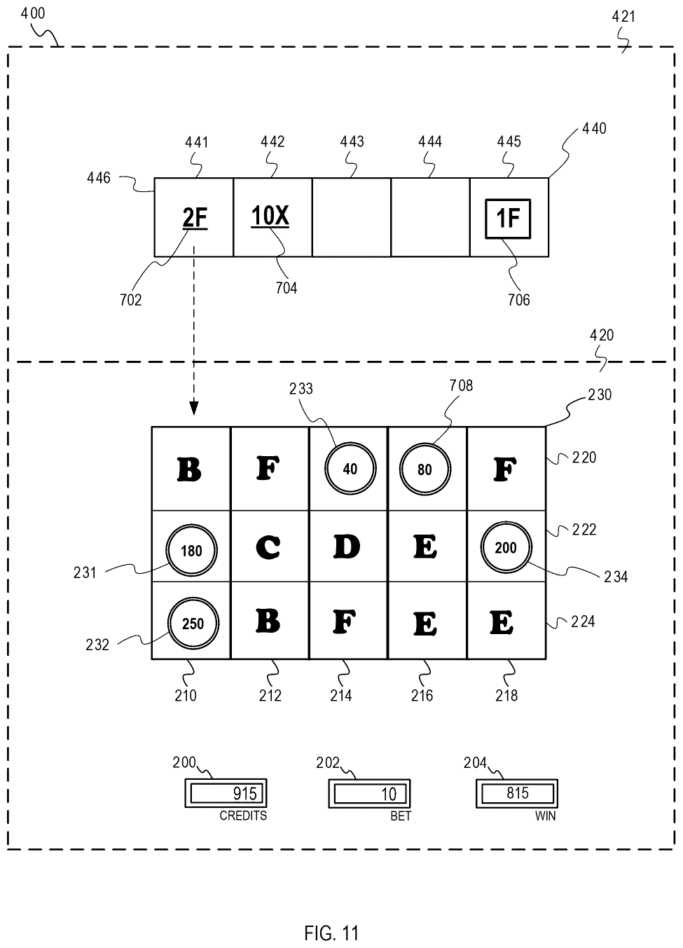

FIG. 8 illustrates an example of applying the single-correlation type enhancer (i.e., flip symbol 702) to enhance value-bearing symbols in a correlated primary-game reel (e.g., reel 210). For example, as shown in FIG. 8, the game-logic circuitry applies, to the value-bearing symbols 231 and 232, two flips based on the face value of the flip symbol 702 (i.e., “2F” refers to two flips). A flip symbol that states “3F” would have three flips, a flip symbol that states “4F” would have four flips, etc. A flip symbol that states “1F” only has one flip. Before the flip (or rotation), the game-logic circuitry awards the face value of the value-bearing symbols 231 and 232 to the credit meter 200. For example, the before the first flip of the value-bearing symbol 231, the game-logic circuitry awards (i.e., adds to the credit meter 200) the “150” credit value that appears on the face of the value-bearing symbol 231. Furthermore, before the first flip of the value-bearing symbol 232, the game-logic circuitry awards the “240” credit value on the face of the value-bearing symbol 232. The game-logic circuitry then determines, via a random number generator, new values for the value-bearing symbols 231 and 232. For instance, as illustrated in FIG. 9, the game-logic circuitry determines a new random value of “175” credits for the value-bearing symbol 231, and the game-logic circuitry determines a new random value of “250” credits for the value-bearing symbol 232. The game-logic circuitry presents the newly determined face values on the respective value-bearing symbols 231 and 232 after the first flip. As shown in FIG. 9, the new randomly-determined values are “175” credits for the value-bearing symbol 231 and “250” credits for the value-bearing symbol 232. As shown in FIG. 10, the game-logic circuitry causes the second flip of the value-bearing symbols 231 and 232 (which awards the values of “175” credits and “250” credits to the credit meter 200), and then, as shown in FIG. 11, the game-logic circuitry generates (via the RNG) additional new values for the value-bearing symbols 232 and 232 (i.e., “180” credits and “250” credits respectively).

In one embodiment, a flip can be utilized to divide up one outcome into multiple awards, which are portions of an already determined award amount based on a single random generated value. For example, the single random generated value may specify that a total award amount of all flips will be a specific value (e.g., one hundred total credits), which is divided up based on the number of flips. For example, if the flip symbol has only one rotation, the game-logic circuitry awards the original value displayed on the value-bearing symbol (e.g., “20” credits) and the second rotation presents the remainder of the total award amount of all rotations minus the amount awarded for the first flip (e.g., the amount shown on the coin after the flip is “80” credits, or rather, the “100” total credits minus the original “20” credits, for a new face value of “80” credits—i.e., 100−20=80). In another example, if the total award amount is determined to be “100” credits, but the flip symbol has multiple rotations, the game-logic circuitry can determine to divide up the total award amount amongst the multiple rotations. For instance, the game-logic circuitry can award the original value displayed on the value-bearing symbol (e.g., “20” credits) leaving the remainder of the total award (i.e., “80” credits) to be divided up amongst the multiple rotations. For example, the first of the rotations can present a new value of “50” credits (leaving a remainder of “30” credits—i.e., 80−50=30). A second of the rotations can award the 50 credit value, and the new value of value-bearing symbol reads “30” credits). In some embodiments, the flips can generate the same value for each flip (e.g., which would be similar to a multiplier type of enhancer symbol). In other embodiments, each flip can utilize a different random generated value for a new value of the value-bearing symbol. In some embodiments, the different amounts can be within a specific range or may include a lower limit and/or upper limit. For example, if a value-bearing symbol displays a first value, the flip symbol can ensure that each flip produces a new value that is at least the amount of the first value or higher. In other embodiments, each flip can generate a value that is within at least a certain percentage of the first value (e.g., within 10% of the original value).

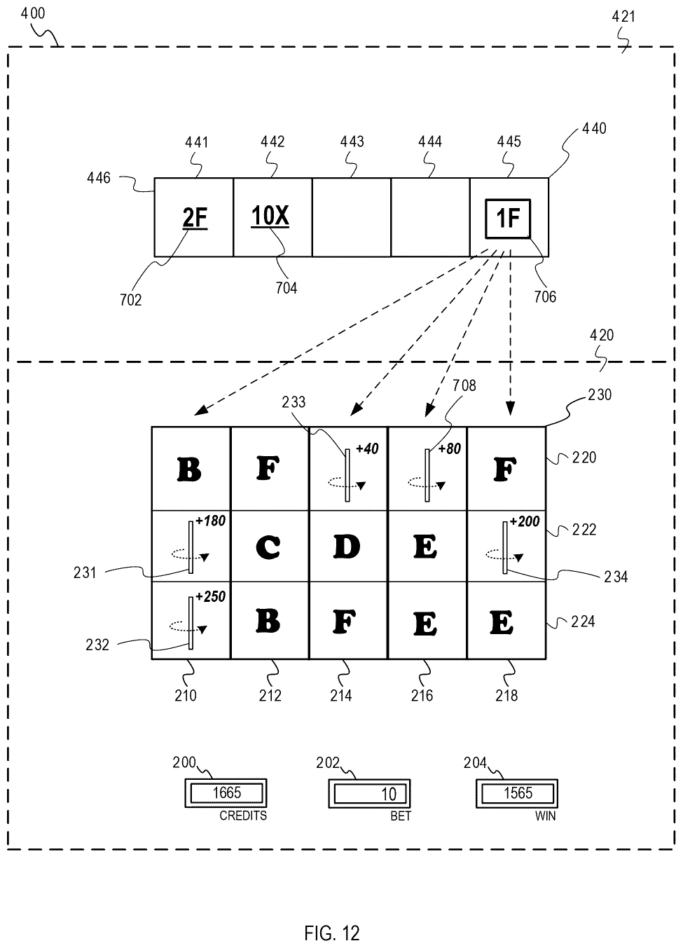

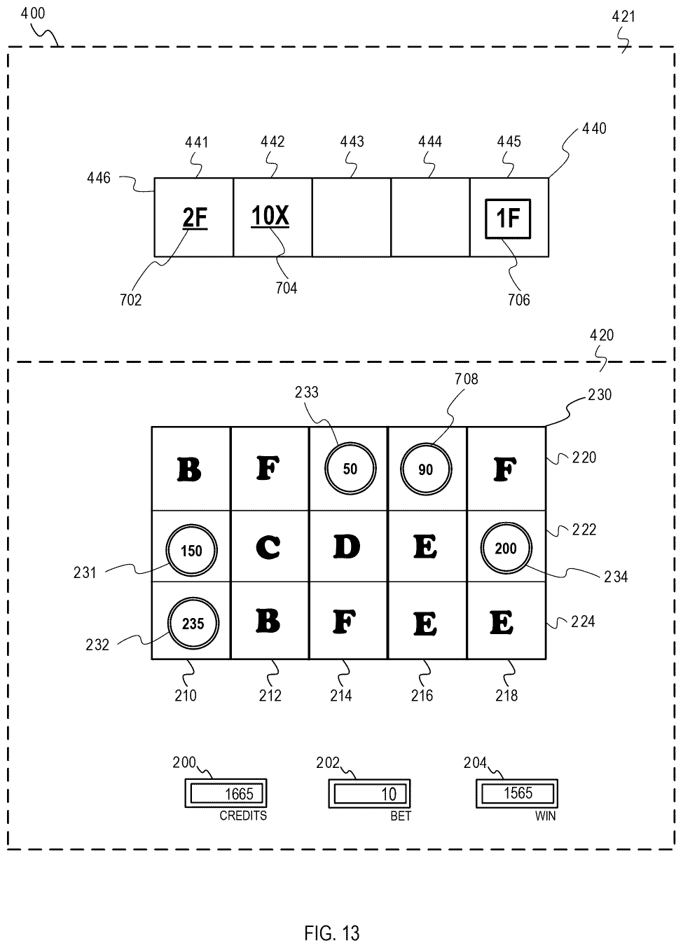

Flip enhancer symbols can be of different types (e.g., single-correlation, multi-correlation, etc.). For example, one type of flip enhancer symbol (e.g., flip symbol 702) may be related (by a positional correlation) to only one of the primary-game reels (e.g., the flip symbol 702 is a single-correlation enhancer symbol which, as shown in FIG. 7-11, only applies enhancement to only the reel 210 directly below the flip symbol 702). However, another type of flip enhancer symbol (e.g., flip symbol 706) applies to multiple primary-game reels based on a one-to-many relationship of positional correlation (e.g., multi-correlation flips can apply to many reels in the primary-game array 230, to specific reels or portions of the reels in the primary-game array 230, to adjacent or directional reels based on the location of the flip symbol, to all reels of the primary-game array 230, etc.). As shown in FIG. 12, the game-logic circuitry (based on determination that the flip symbol 706 is a multi-correlation enhancer symbol that applies to all primary-game reels) causes the values of all of the value-bearing symbols 231, 231, 233, 234, and 708 to be awarded (to the credit meter 200) and then flipped once. In response to the flip, the game-logic circuitry generates (via RNG) and animates new values for the value-bearing symbols 231, 231, 233, 234, and 708, as shown in FIG. 13.

In some embodiments, flips and multipliers can be provided separately in different versions of the secondary game or they can be provided in the same game. In some embodiments, if a multiplier symbol and a flip symbol are applied to the same value-bearing symbol during one spin of the secondary game, the game-logic circuitry can apply the multipliers before or after the flips. In some embodiments, the game-logic circuitry can apply a multiplier after each flip occurs, so that each amount that gets presented on a flip is multiplied. In another embodiment, the amounts awarded prior to flips can be added up in a secondary meter, and after the flip values are added up, the multiplier can be applied to the total of the awarded flip amounts. The final amount presented on the value-bearing symbol after the flips can further be multiplied. In some embodiments, multiple flip enhancer symbols can be applied to the same value-bearing symbol during a single spin/round of the secondary game. In some embodiments, a multiplier can award a value of the multiple (as for the case of flips), then reset to a base value before being multiplied again (such as before being multiplied by a different multiplier). Thus, in some embodiments, the various multipliers can be additive of each other, whereas in other embodiments, the multipliers can be multiplicative of each other or some other combination of order of operations.

In one embodiment, a flip symbol can be an expander type of enhancer symbol. For example, an expander flip applies enhancement to the primary-game reel directly below the flip symbol and also applies enhancement to any adjacent primary-game reel. Further, as mentioned previously, an enhancer symbol can have a specific directional (e.g., horizontal positional) correlation. Thus, a flip symbol may include an arrow that points either to the left or right, and thus any primary-game reels that are directly below and in the specific direction of the pointing arrow are enhanced (e.g., as shown for the flip symbol 706).

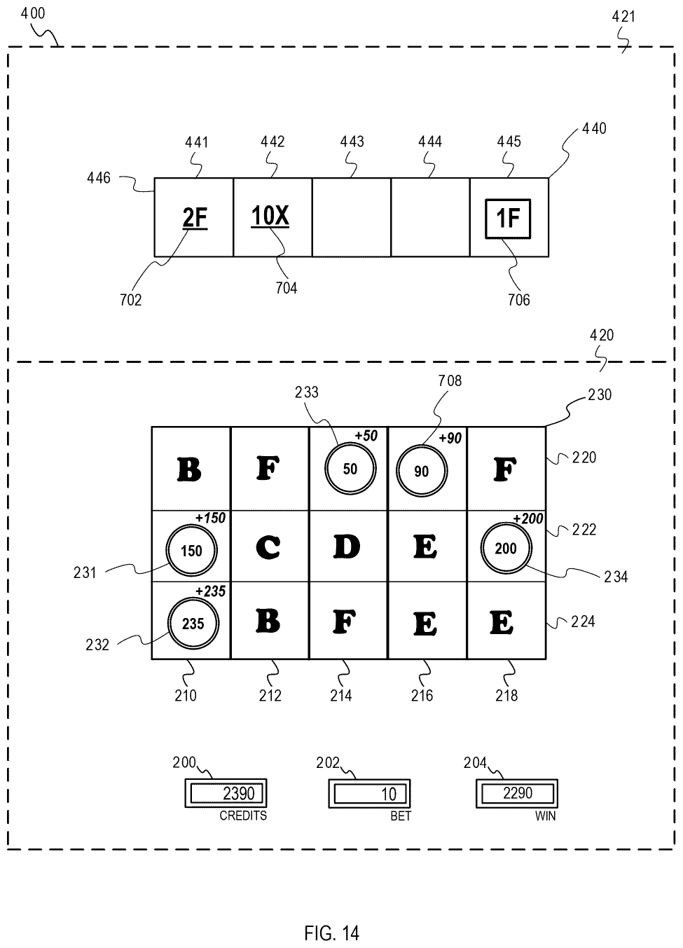

Referring to FIG. 14, the multiplier symbol 704 is a single-correlation type of enhancer symbol, and thus only applies to a single primary-game reel to which it is mapped (e.g., the reel 212 directly below the multiplier symbol 704). Because there are no value-bearing symbols in reel 212, the multiplier symbol 704 does not get applied to any value-bearing symbol in the primary-game array 230. Furthermore, after applying the flip symbols 702 and 706, the game-logic circuitry determines that no re-spin trigger has occurred (e.g., no “RE-SPIN” symbol appeared for the second spin of the reel 446). Thus, the game-logic circuitry terminates play of the secondary game and awards all current values of value-bearing symbols presented in the primary-game array 230 (as shown in FIG. 14, which total value is added to the credit meter 200).

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the secondary being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of operating a gaming machine, the method comprising:
accepting, via a value input device, a physical item associated with a monetary value to establish a monetary balance;
presenting, by a presentation assembly, primary-game reels that form a primary-game array for a primary game, the primary-game reels bearing a plurality of primary-game symbols and a plurality of special symbols;
conducting, by game-logic circuitry, the primary game, wherein the primary game includes operations that comprise:
conducting, by the game-logic circuitry via a random number generator, one or more primary-game spins of the primary-game reels for the primary game, each primary-game spin including spinning and stopping the primary-game reels to land, in the primary-game array, a first set of symbols from the plurality of primary-game symbols and a second set of symbols from a plurality of special symbols;
determining, by the game-logic circuitry via the random number generator during the one or more primary-game spins, a random trigger to present play of a secondary game using a secondary-game array, wherein the secondary-game array comprises a plurality of portions within which a secondary determination event can occur during the secondary game, wherein each one of the plurality of portions corresponds to at least a respective one of the primary-game reels according to a positional correlation; and
conducting, by the game-logic circuitry in response to determining the random trigger, the secondary game, wherein for each spin of the secondary game, the game-logic circuitry performs additional operations that comprise:
animating, via the game-logic circuitry based on the random number generator, occurrence of the secondary determination event in at least one of the plurality of portions of the secondary-game array; and
in response to animating the occurrence of the secondary determination event, enhancing, by the game-logic circuitry, at least one of the second set of symbols on the at least a respective one of the primary-game reels based on the positional correlation.

2. The method of claim 1, wherein animating the occurrence of the secondary determination event comprises animating presentation, by the game-logic circuitry, of at least one randomly selected enhancer symbol within the at least a respective one of the plurality of portions of the secondary-game array.

3. The method of claim 2, further comprising:
determining, by the game-logic circuitry in response to animating the presentation of the at least one randomly selected enhancer symbol, a type of the positional correlation based on a type of the at least one randomly selected enhancer symbol, wherein the type of the positional correlation maps a first position of the at least one of the plurality of portions within the secondary-game array to a relative second position of the at least a respective one of the primary-game reels within the primary-game array.

4. The method of claim 3, wherein the type of the positional correlation comprises one of a single-correlation type or a multi-correlation type, wherein the single-correlation type correlates the each one of the plurality of portions to a single one of the primary-game reels, and wherein the multi-correlation type correlates the each one of the plurality of portions to multiple ones of the primary-game reels.

5. The method of claim 3, wherein the additional operations for the secondary game further comprise:
after enhancing the at least one of the second set of symbols, locking, by the game-logic circuitry, the at least a respective one of the primary-game reels that includes the at least one of the second set of symbols;
spinning, by the game-logic circuitry, additional ones of the primary-game reels that do not include any of the plurality of special symbols, wherein the spinning the additional ones of the primary-game reels causes a third set of symbols from the plurality of special symbols to appear randomly on at least an additional one of the primary-game reels; and
performing, by the game-logic circuitry, an additional spin of the secondary game.

6. The method of claim 5 further comprising:
for the additional spin, animating, via the game-logic circuitry, presentation of an additional randomly selected enhancer symbol within an additional one of the plurality of portions of the secondary-game array; and
in response to animating the presentation of the additional randomly selected enhancer symbol, enhancing, by the game-logic circuitry, at least one of the third set of symbols on the additional one of the primary-game reels, wherein the additional one of the primary-game reels corresponds, based on the positional correlation, to the additional one of the plurality of portions of the secondary-game array.

7. The method of claim 5, further comprising,
determining, by the game-logic circuitry for the additional spin, that no enhancer symbol appears in the at least one of the plurality of portions of the secondary-game array; and
in response to the determining that no enhancer symbol appears in the at least one of the plurality of portions of the secondary-game array, determining, via the game-logic circuitry for the additional spin, to not enhance the at least one of the second set of symbols on the at least a respective one of the primary-game reels.

8. The method of claim 2, wherein the at least one randomly selected enhancer symbol comprises at least one of a multiplier symbol or a dynamic enhancer symbol.

9. The method of claim 8, wherein the second set of symbols comprise one or more value-bearing symbols.

10. The method of claim 9, wherein animating the presentation of the at least one randomly selected enhancer symbol comprises animating presentation of the dynamic enhancer symbol within the at least one of the plurality of portions of the secondary-game array, and wherein enhancing the at least one of the second set of symbols on the at least a respective one of the primary-game reels based on the positional correlation further comprises:
animating, by the game-logic circuitry in response to animating the presentation of the dynamic enhancer symbol, one or more rotations of a value-bearing symbol from the one or more value-bearing symbols;
before a rotation occurs, awarding a first value presented on the value-bearing symbol; and
after the rotation occurs, presenting a second value on the value-bearing symbol, wherein the second value is determined by the game-logic circuitry via a random number generator.

11. The method of claim 10, further comprising randomly selecting, by the game-logic circuitry prior to occurrence of the rotation, the second value to be within a range of values related to a percentage of the first value.

12. The method of claim 1, wherein the secondary-game array comprises at least one row for a horizontal reel configuration, wherein the plurality of portions of the secondary-game array comprise a first set of columns, wherein the primary-game reels comprise a second set of columns, wherein each primary-game reel is a different one of the second set of columns, and where each of the first set of columns corresponds to at least one respective one of the second set of columns based on the positional correlation.

13. The method of claim 12, wherein the first set of columns are positioned physically above the second set of columns, and wherein the positional correlation is a one-to-one relationship between a first physical position of the each of the first set of columns and a second physical position of a respective one of the second set of columns, wherein the first physical position is located directly above the second physical position.

14. The method of claim 12, wherein the first set of columns are positioned physically above the second set of columns, and wherein the positional correlation is a one-to-many correlation between a first physical position of the each of the first set of columns and one or more second physical positions of multiple ones of the second set of columns, wherein the multiple ones of the second set of columns comprise a first column of the second set of columns positioned directly below the first physical position and at least one second column of the second set of columns, wherein the at least one second column is adjacent to the first column.

15. The method of claim 1, wherein determining the random trigger comprises one or more of:
determining that the second set of symbols includes a threshold number of special symbols;
determining that the second set of symbols appears on a threshold number of the primary-game reels;
determining that the second set of symbols are oriented in a specific manner;
determining that the second set of symbols appear on a threshold number of adjacent ones of the primary-game reels; or
determining that the second set of symbols includes a specific type of the plurality of special symbols.

16. A system comprising:
a value input device configured to accept a physical item associated with a monetary value to establish a monetary balance;
a presentation assembly configured to present primary-game reels that form a primary-game array for a primary game, the primary-game reels bearing a plurality of primary-game symbols and a plurality of special symbols; and
game-logic circuitry configured to execute instructions which perform operations that cause the system to:
land, on the primary-game reels, at least some of the plurality of primary-game symbols and a special symbol from the plurality of special symbols, wherein the special symbol lands on one of the primary-game reels;
determine a random trigger to present play of a secondary game that uses a secondary-game array, wherein the secondary-game array comprises a plurality of portions; and
in response to determination of the random trigger,
animate, based on a random number generator, occurrence of a secondary determination event in one of the plurality of portions of the secondary-game array;
determine, in response to animation of the occurrence of the secondary determination event, a positional correlation between a first position of the one of the plurality of portions within the secondary-game array and a second position of the one of the primary-game reels within the primary-game array; and
enhance, in response to determination of the positional correlation, the special symbol.

17. One or more non-transitory, machine readable media having instructions stored thereon, which instructions, when executed by one or more electronic processors, cause a gaming system to perform operations comprising:
accepting, via a value input device, a physical item associated with a monetary value to establish a monetary balance;
presenting, by a presentation assembly, primary-game reels that form a primary-game array for a primary game, the primary-game reels bearing a plurality of primary-game symbols and a plurality of special symbols;
conducting, by game-logic circuitry, the primary game, wherein the primary game includes operations that comprise:
conducting, by the game-logic circuitry via a random number generator, one or more primary-game spins of the primary-game reels for the primary game, each primary-game spin including spinning and stopping the primary-game reels to land, in the primary-game array, a first set of symbols from the plurality of primary-game symbols and a second set of symbols from a plurality of special symbols;
determining, by the game-logic circuitry via the random number generator during the one or more primary-game spins, a random trigger to present play of a secondary game using a secondary-game array, wherein the secondary-game array comprises a plurality of portions within which a secondary determination event can occur during the secondary game, wherein each one of the plurality of portions corresponds to at least a respective one of the primary-game reels according to a positional correlation; and
conducting, by the game-logic circuitry in response to determining the random trigger, the secondary game, wherein for each spin of the secondary game, the game-logic circuitry performs additional operations that comprise:
animating, via the game-logic circuitry based on the random number generator, occurrence of the secondary determination event in at least one of the plurality of portions of the secondary-game array; and
in response to animating the occurrence of the secondary determination event, enhancing, by the game-logic circuitry, at least one of the second set of symbols on the at least a respective one of the primary-game reels based on the positional correlation.
